(19) United States
(12) Patent Application Publication
(10) Pub. No.: US 2024/0367268 A1
(43) Pub. Date: Nov. 7, 2024

(54) QUALITY MONITORING OF WELDING PROCESS

(71) Applicant: MAGNA INTERNATIONAL INC., AURORA (CA)

(72) Inventor: Nikhil BOLAR, Royal Oak, MI (US)

(73) Assignee: MAGNA INTERNATIONAL INC., AURORA (CA)

(21) Appl. No.: 18/292,636

(22) PCT Filed: Aug. 18, 2022
(86) PCT No.: PCT/US2022/040740

§ 371 Date: Jan. 26, 2024

Related U.S. Application Data
(60) Provisional application No. 63/234,888, filed on Aug. 19, 2021.

(51) Int. Cl. B23K 31/12; B23K 11/00; B23K 11/25

(52) U.S. Cl. CPC B23K 31/125; B23K 11/0046; B23K 11/25

(57) ABSTRACT

The present disclosure is related to a method of welding a component, such as a fastener, with a base metal. The method includes the step of stud welding a component with a base metal to create at least one weld joint using at least one electrode. The method continues with the steps of emitting ultrasonic waves from an ultrasonic sensor on an electrode and receiving reflections of those ultrasonic waves with the ultrasonic sensor. The method proceeds with the step of generating an acoustic map based on the reflections of the ultrasonic waves. The method continues with the step of analyzing the acoustic map to determine a quality of the at least one weld joint.

### CROSS-REFERENCE TO RELATED APPLICATION

This PCT International Patent application claims the benefit of U.S. Provisional Patent Application Ser. No. 63/234,888 filed on Aug. 19, 2021 titled “Quality Monitoring Of Welding Process,” the entire disclosure of which is hereby incorporated by reference.

### BACKGROUND

### 1. Field

The present disclosure is related generally to an improved welding system and a method of welding two or more workpieces together and analyzing weld quality.

### 2. Related Art

Drawn arc stud welding (also known as stud welding), capacitor discharge welding, and projection welding are two different types of welding that are commonly applied to bond metal fasteners with base metals or substrates. In drawn arc stud welding, an electrode, which could have the form of a chuck, is engaged with the fastener and moved against the base metal, which is grounded. A large voltage is applied to the chuck, thereby imparting a voltage difference between the fastener and the base metal. The electrode lifts the fastener off of the base metal, and an arc is created, thereby melting some material from both the stud and the base metal. With the material melted, the fastener is then urged against the base metal to join the fastener with the base metal. Upon cooling, the metal that melted during this operation solidifies to form a weld joint between the fastener and the base metal. Capacitor discharge welding is similar to drawn arc stud welding but involves pre-charging a capacitor and may not involve moving the fastener away from the base metal because the gap that forms the arc may be created by the vaporization of an ignition tip that is on the fastener.

In projection welding, the fastener (or a base substrate material) has one or more projections pre-formed onto it, and those projections are brought into contact with the base metal by an electrode. A force is applied to the electrode as current is passed through the system. An internal resistance of the metal workpieces produces heat which is concentrated at the projection(s). Once a sufficient temperature is reached, the force applied by the electrode causes the projection(s) to melt and collapse, thereby fusing the fastener with the base metal after cooling.

These welding processes are frequently employed in the production of automotive parts to bond either male or female fasteners with a component, thereby allowing the component to later be fasted with another component of the vehicle using one or more mechanical fasteners. Sometimes projections are also present in a non-fastener workpiece (like sheet metal or casting) and the projection welding process can involve the joining of two metal substrates.

Checking the quality of the weld joints is often a difficult and time-consuming operation that involves visual inspection and destructive testing. This significantly increases the time for inspection and evaluation with added costs. There is a significant and continuing need for an improved weld inspection methodologies and process control plans.

### SUMMARY

One aspect of the present disclosure is related to a welding assembly that includes at least one electrode which is electronically connected with a power source and is configured to run a current through a component, such as a fastener, and a base metal (or two metal substrates) to create at least one weld joint between the component and the base metal. An ultrasonic sensor or transceiver is incorporated with the electrode and is configured to emit ultrasonic waves through the component and the at least one weld joint. An electronic device is in electrical communication with the ultrasonic sensor and is configured to generate an acoustic map of the at least one weld joint.

According to another aspect of the present disclosure, the ultrasonic sensor is integral with the at least one electrode.

According to yet another aspect of the present disclosure, the ultrasonic sensor is a separate component from the at least one electrode and is fixedly attached with the at least one electrode.

According to still another aspect of the present disclosure, the component is a fastener.

According to a further aspect of the present disclosure, the fastener is pre-formed with a plurality of projections that are configured to melt to form the at least one weld joint.

According to yet a further aspect of the present disclosure, the component and the base metal are made of the same type of metal.

According to still a further aspect of the present disclosure, the electronic device is configured to compare the acoustic map of the at least one weld joint to at least one predetermined threshold to establish a quality of the weld joint.

According to another aspect of the present disclosure, the component is a metal substrate that is pre-formed with projections.

Another aspect of the present disclosure is related to a method of welding a component, such as a fastener, with a base metal (or two metal substrates where one substrate is enabled with features for welding). The method includes the step of stud welding a component with a base metal to create at least one weld joint using at least one electrode. The method continues with the steps of emitting ultrasonic waves from an ultrasonic sensor on an electrode and receiving reflections of those ultrasonic waves with the ultrasonic sensor. The method proceeds with the step of generating an acoustic map based on the reflections of the ultrasonic waves. The method continues with the step of analyzing the acoustic map to determine a quality of the at least one weld joint.

According to another aspect of the present disclosure, the ultrasonic sensor is integral with the electrode.

According to yet another aspect of the present disclosure, the ultrasonic sensor is separate from the electrode and is fixedly attached with the electrode.

According to still another aspect of the present disclosure, the component is a fastener.

According to a further aspect of the present disclosure, the fastener is pre-formed with at least one projection that melts during the welding step.

According to yet a further aspect of the present disclosure, the component is a substrate.

According to still a further aspect of the present disclosure, the welding step is drawn arc stud welding, capacitor discharge welding, or projection welding.

### BRIEF DESCRIPTION OF THE DRAWINGS

These and other features and advantages of the invention will become more readily appreciated when considered in connection with the following description of the presently preferred embodiments, appended claims and accompanying drawings, in which:

FIG. 1 is a perspective view of an exemplary welding assembly during a welding operation to attach a fastener with a base metal;

FIG. 2A is a cross-sectional view of a first exemplary embodiment of an electrode;

FIG. 2B is a cross-sectional view of a second exemplary embodiment of the electrode;

FIGS. 3A, 3B, 3C shows the different steps in the projection welding process;

FIG. 3D shows an alternative to 3A incorporating projections in a base metal substrate in the projection welding process;

FIG. 3E shows another embodiment of the projection welding apparatus;

FIGS. 4A, 4B, 4C, 4D shows the different steps in the drawn arc welding process;

FIG. 4E shows an alternative to the first step with either a stud or a fastener with projections;

FIG. 5 is a perspective view of an alternate embodiment of the welding assembly during a welding operation to attach a fastener with a base metal;

FIG. 6 is a cross-sectional view of a third embodiment of the electrode;

FIG. 7A is a perspective view of the third embodiment of the electrode;

FIG. 7B is a perspective view of a fourth embodiment of the electrode;

FIG. 8 is a perspective elevation view of a fastener welded to a base metal;

FIGS. 9A and 9B are an acoustic maps illustrating high quality welds;

FIG. 10A is a collection of acoustic maps that illustrates several varying low quality and defective welds joints (each carried out under one operation) between the fastener and the base metal;

FIG. 10B is a collection of acoustic maps that illustrates several varying low quality and defective welds joints (each carried out under one operation) between the fastener and the base metal; and

FIG. 11 is a schematic view of an exemplary welding system for creating and analyzing at least one weld joint between a fastener and a base metal.

### DESCRIPTION OF THE ENABLING EMBODIMENT

Referring to the figures, wherein like numerals identify corresponding parts throughout the several views, one aspect of the present disclosure is related to a welding assembly 20 that is adapted to both form and analyze the quality of a weld joint 22 between a component, such as a fastener 24, and a base metal 26. As discussed in further detail below, this welding assembly 20 can be integrated into an assembly line to allow for the quality of the weld joints 22 to be checked quickly, in real time so that defective weld joints can be identified immediately and appropriate action can be taken with minimal delay in the operation of the assembly line.

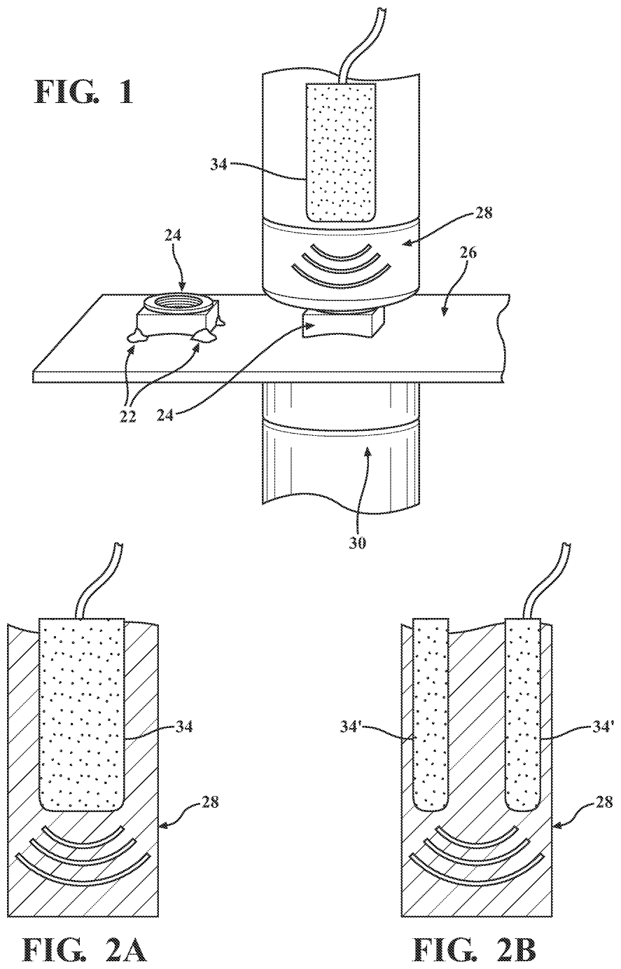

Referring to FIG. 1, a first exemplary embodiment of the welding assembly 20 is generally shown. The welding assembly 20 includes a first electrode 28 and a second electrode 30 that have welding surfaces that face towards one another. Prior to welding, the base metal 26 and the fastener 24 are brought to a space between the welding surfaces. In the exemplary embodiment, the base metal 26 is generally planar (e.g., a sheet of metal), and the fastener 24 is a female fastener with internal threads. The fastener 24 has a bottom surface with four corners with projections that protrude downwardly towards the base metal 26. Thus, when the fastener 24 is placed against the planar base metal 26, the fastener 24 contacts the base metal 26 at the four projections but not in the areas between the corners.

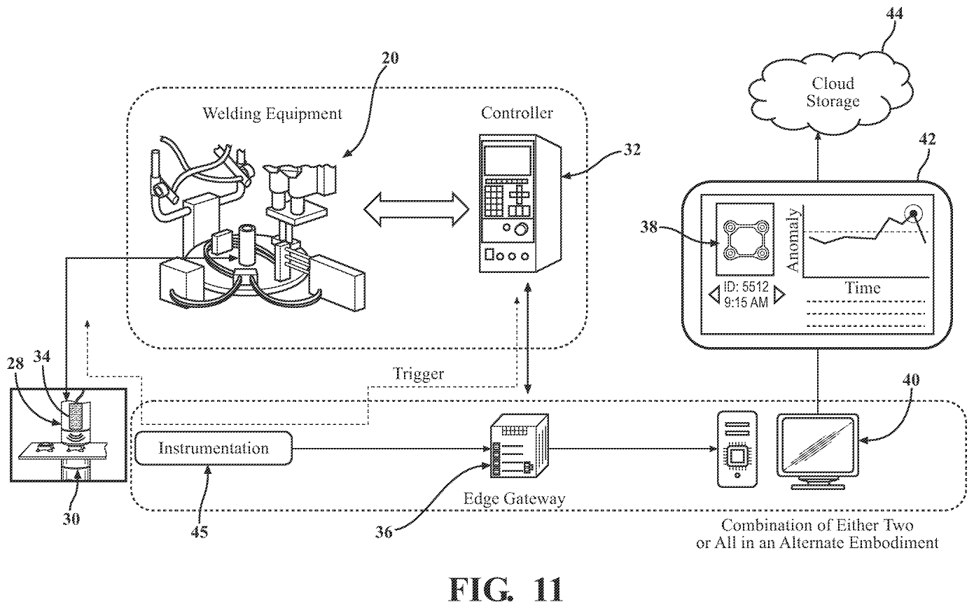

The electrodes 28, 30 are electrically connected with an electrical power source, which is controlled by a controller 32 (shown schematically in FIG. 11). In operation, with an initial force applied vertically, a trigger event from a controller 32 enables a voltage differential across the electrodes 28, 30, thereby drawing a current from one of the electrodes 28, through the fastener 24, into the base metal 26 via the four corners, and ultimately to the other electrode 30. At the four corners, the materials of the fastener 24 and of the base metal 26 both melt, depending on the features of these components. The voltage differential is then cut, thereby allowing the molten metal to cool and form four distinct weld joints 22 (one at each corner) between the fastener 24 and the base metal 26. In other embodiments, the fastener 24 may take a range of different configurations, such as a male fastener with external threads. Additionally, any suitable number of weld joints 22 (e.g., one, two, three, or five or more) can be formed between the fastener 24 and the base metal 26, depending on the shapes of these components. The fastener 24 and the base metal 26 are preferably made of the same type of metal, e.g., steel, an aluminum steel, aluminum, or an aluminum alloy. Dissimilar materials may also be employed in some cases. This process can also be applied to a welding operation between two or more metal substrates (sheet metal or any suitable base substrate) instead of a fastener. In some embodiments where the welding is a drawn arc welding operation, the fastener 24 is lifted to a preset height away from the base metal 26. An arc forms and melts the base of the fastener 24 at the projections, and then the fastener 24 is displaced back into contact with the base metal 26 to form a joint upon cooling.

In the first embodiment (illustrated in FIG. 1 and FIG. 2A), an ultrasonic sensor 34 is integrated within a first electrode 28 of the pair of electrodes 28, 30. Upon cooling of the weld joints 22 and with the welding surface of the first electrode 28 remaining in physical contact with the fastener 24, the ultrasonic sensor 34 is activated to emit ultrasonic waves from the first electrode 28, through the fastener 24, and into the weld joints 22. The ultrasonic waves are reflected back to the ultrasonic sensor 32, which is in electrical communication with a computing instrumentation 45, through an edge-gateway 36 (see FIG. 11). The computing instrumentation 45 may then produce a contoured map 38 of the acoustic pattern that is generated from the ultrasonic sensor 34. This contoured map 38 is sent to a data storage medium and to an analytics computing system 40. The analytics computing system 40 could be any suitable type of computing device including, for example, a desktop computer, a laptop computer, a server, a tablet, etc. It can appreciated that the three unit blocks 45, 36 & 40 can be either established as a combination of two or all in an alternative setup. In an alternate embodiment (illustrated in FIG. 2B), the ultrasonic sensor 34′ is ring-shaped.

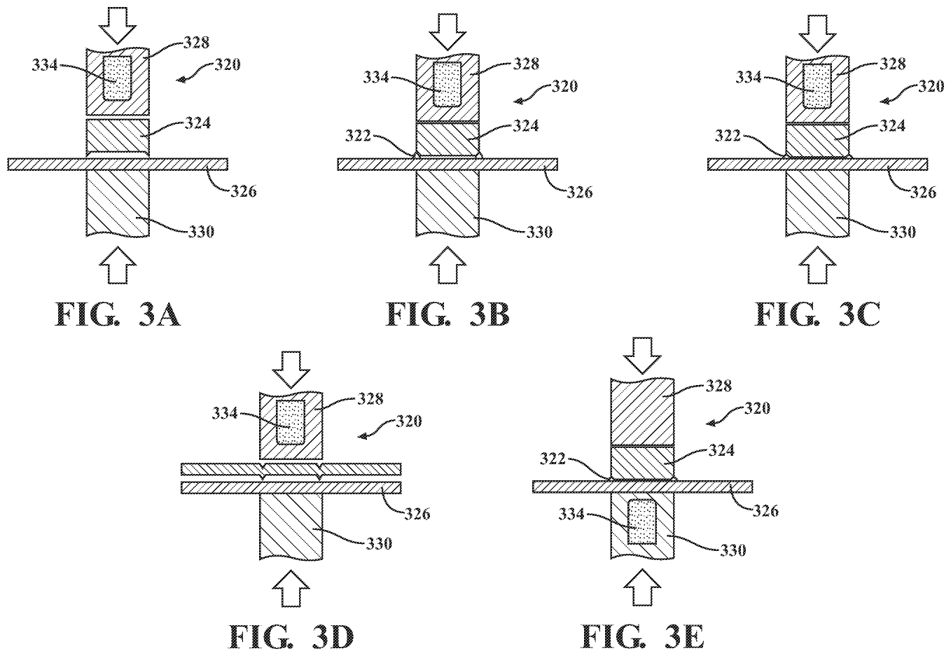

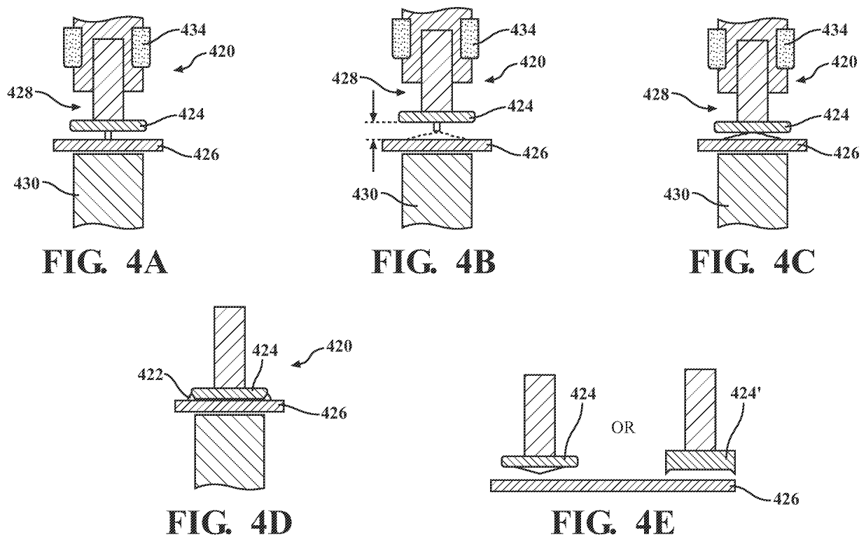

The welding assembly 20 may take the form of a projection welding assembly 420 (such as the one shown in FIGS. 4A-4D), a drawn arc stud welding assembly 320 (such as the one shown in FIGS. 3A-3EE), or a capacitor discharge welding assembly. In the projection welding assembly, a force is applied by the electrodes on the fastener and the base metal. A voltage differential is applied across the electrodes, thereby generating a current that runs through the fastener and the base metal. The current warms and melts the projections of the fastener where they meet the base metal and causes the projections to collapse. Upon cooling, a joint is formed between the fastener and the base metal.

With like numerals, separated by a prefix of “3” identifying like components with the embodiments described above, in drawn arc stud welding, the fastener 324 is pre-formed with at least one ignition tip. Upon the introduction of the voltage differential across the electrodes 328, 330, the fastener 324 is backed away from the base metal 26 to generate an arc between the ignition tip and the base metal 26. Heat produced by the arc causes melting of the ignition tip. The fastener 324 is then forced into the molten pool of metal produced by the melting of the ignition tip. Upon cooling, at least one weld joint 324 is formed between the fastener 324 and the base metal 326. In alternate embodiments, one or more projections on the fastener 324 may serve in place of the ignition tip. Capacitor discharge welding follows a similar procedure, but capacitors are pre-charged on the power supply.

With like numerals, separated by a prefix of “4” identifying like components with the embodiments described above, in the embodiment of FIGS. 4A-4C, the ultrasonic sensor 434 is ring shaped and circumferentially surrounds the cylindrically shaped first electrode 428. The tip end of the stud or fastener 424 has a feature 29 along a central axis of the first electrode 28. The tip of the fastener or stud 424 melts upon the application of the voltage differential, thereby forming a melt pool (see FIG. 4C). The melt pool cools to form the weld joint 422 between the fastener 424 and the base metal 26. After welding is completed (see FIG. 4D), the ultrasonic sensor 434 emits the ultrasonic waves downwardly towards and across the entire welding surface with the base metal 26. Thus, in operation, the ultrasonic waves pass through the entirety of the fused zone between the fastener or stud 424 and the base metal 26. The fastener or stud may take different forms, such as the stud 424 or the stud 424′ of FIG. 4E.

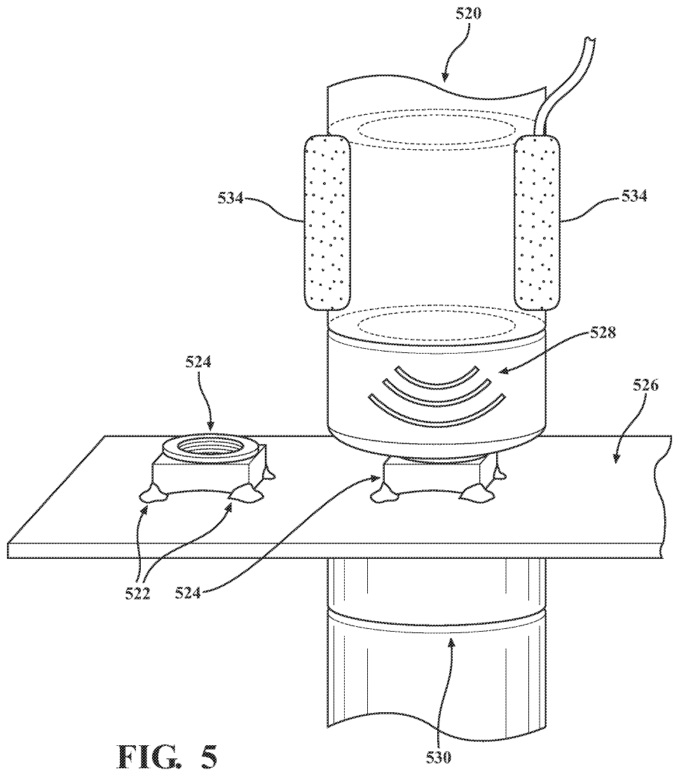

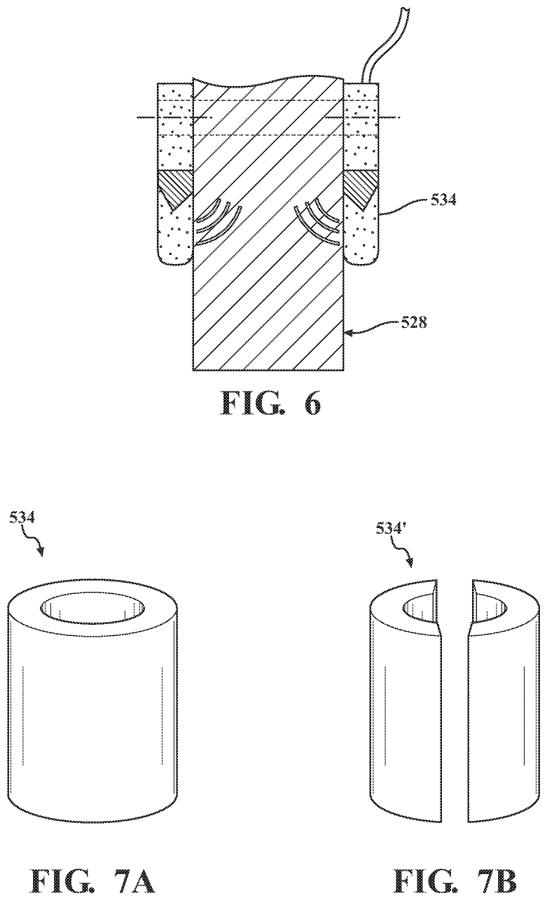

Referring now to the embodiments of FIGS. 5-7, wherein like numerals, separated by a prefix of “5,” identify like components with the above embodiments, the ultrasonic sensor 534 is an external device that can be fixedly attached with an electrode 528 of an existing welding device 520. In these embodiments, the ultrasonic sensor 534 emits the ultrasonic waves downwardly and inwardly to cover the entire welding surface of the first electrode 528. In the embodiment of FIG. 7A, the ultrasonic sensor 534 has an annular shape and is made as a single piece. In the embodiment of FIG. 7B, the ultrasonic sensor 534′ is made as two pieces that each extend through a one hundred and eighty-degree (180°) arcs. In either embodiment, the ultrasonic sensor 534, 534′ may be fixedly attached with the first electrode 28 through any suitable attachment means, e.g., mechanical fasteners.

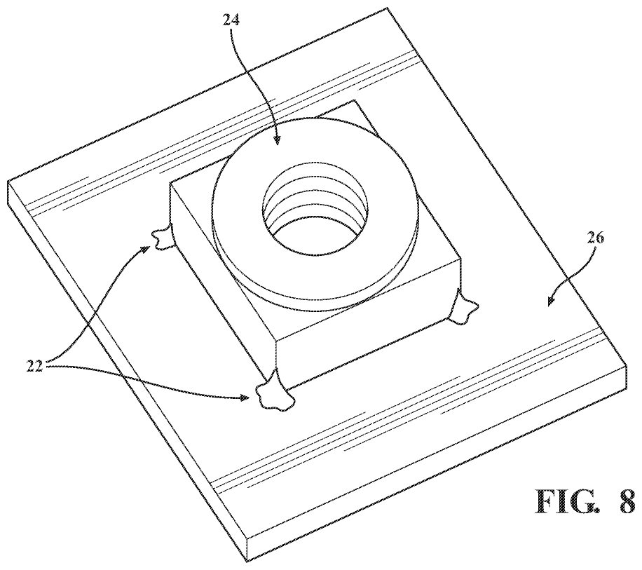

Referring now to FIG. 8, a fastener 24 is shown as being welded with the base metal using any of the welding assemblies described above. As shown, the weld joint 22 between the fastener 24 and the base metal 26 includes four distinct connections at the four corners of the fastener 24 where the metals of the fastener 24 and the base metal 26 have been joined together.

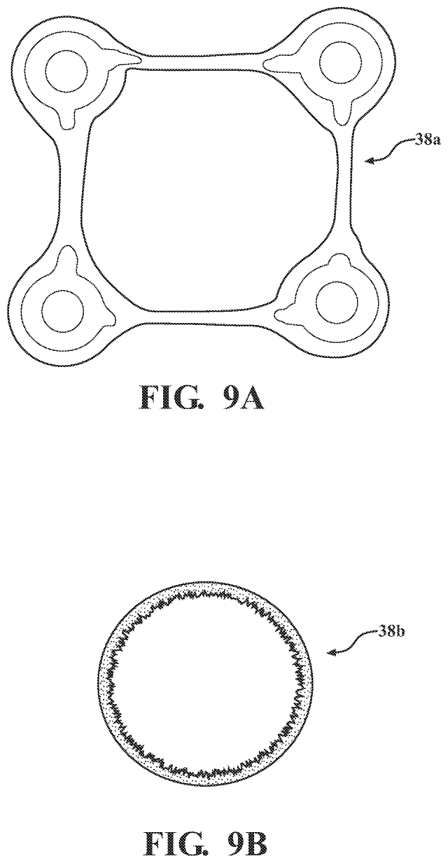

FIGS. 9A and 9B show an exemplary contoured map 38 of a fastener with a good quality weld joint indicating a strong connection between the fastener and the base metal. Specifically, FIG. 9A illustrates a contour map 38a of a fastener that is joined with the base metal at four connection points (for example, the embodiment of FIG. 8), and FIG. 9 illustrates a contour map 38b of a fastener with a single, larger connection point. In both of these examples, the contour map 38a, 38b of each connection point exhibits a central dense and uniform region where fusion is the strongest and radially decreases towards the outer unfused and non-contact zone.

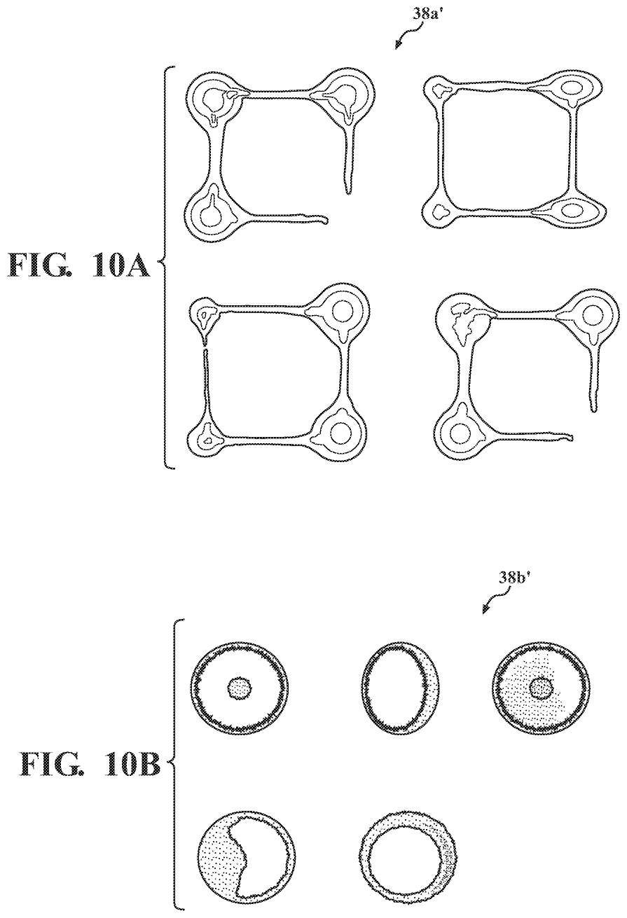

FIGS. 10A and 10B illustrates contoured maps 38a′, 38b′ of four defective or bad quality weld joints. Such inadequate weld joints could result from an inadequate arc at one or more of the projections, cold welds, impurities, electrode misalignment, unfused zones, rapid cooling resulting in shrinkages, interfacial fractures, or an oval shaped weld nugget. The welding system of the present disclosure is able to make the determination of whether a weld joint is a good weld joint that meets tolerances or is a bad weld joint and should be rejected very rapidly, and defective parts can be scrapped or otherwise separated for further analysis with little intrusive analysis. The determination is made by comparing the contoured map 38a′, 38b′ to predetermined thresholds. For example, if an insufficient volume of sonic waves were able to pass through one of the connection points between the fastener and the base metal, then the central contour may be non-existent, small in size, misshapen, it may have a central area that conveys less ultrasonic waves than the surrounding area, etc. All three of these properties, and others, may be compared against predetermined thresholds which are related to a good quality weld and, if any of these properties falls short of those predetermined thresholds, then the weld joint is determined to be potentially of inferior quality. The part can then be set aside for further analysis or discarded for scrap. Further, an assembly line can be stopped almost immediately if it is determined that the welding equipment is repeatedly making bad quality welds so that the problem can be fixed prior to additional bad welds being made on products.

Referring now to FIG. 11, another aspect of the present disclosure is related to a welding system that is able to both create and check the quality of weld joints. The system includes a weld assembly 20, such as any of the embodiments discussed above. The system includes an edge gateway 36, an edge computer 40, and a display 42 and is in communication with a cloud storage device 44. The edge gateway device 36 is an integrated gateway between the weld control system and the instrumentation. It interacts with the equipment to obtain the process data and times and the triggers sent to the ultrasonic instrumentation. It also receives the contour from the instrumentation 45 and sends it to the edge computer 40, which establishes the quality of the weld using machine learning models and weld signature templates. The associated process parameters and process sequence identification numbers (weld ID numbers) are also sent to the edge computer 40. The data from the instrumentation unit can be directly sent to the edge computer 40 as well. The edge computer 40 may be near the manufacturing process and can assess each weld signature immediately after welding and display the results on a screen and/or transmit the results to the cloud database of remote viewing. The three blocks can be established with a combined of instrumentation application 45 and edge computer 40 or additionally with the edge gateway 36 depending on the available computing resources.

The data produced by the welding system and uploaded to the cloud storage 44 or the computing storage device (edge computer) 40 may include a database that matches the contoured maps 38 with part numbers of the parts produced by the welding operation. Thus, the contoured maps 38 and any additional data generated by the ultrasonic sensor 34 or the welding assembly 20 can be accessed later and associated with each part that is welded by the welding system, e.g., in the event of a failure of a part.

Another aspect of the present disclosure is related to a method of welding a component, such as a fastener 24, with a base metal 26 to produce a part, such as an automotive part. The method includes the step of contacting the first electrode 28, which includes an ultrasonic sensor 34, with the fastener 24 and bringing the fastener 24 into contact or near contact with the base metal 26. The method continues with imparting a voltage difference between the electrode 28 and the base metal 26 to run a current through the fastener 24 and the base metal 26. The flow of current heats and melts some material of both the fastener 24 and the base metal 26 at the locations where the fastener 24 contacts the base metal 26. The method proceeds with cooling the molten material to form at least one weld joint 22 that fixedly attaches the fastener 24 with the base metal 26.

The method continues with the step of activating the ultrasonic sensor 34 on the electrode 28 to emit ultrasonic waves through the at least one weld joint 22 and to reflect the ultrasonic waves back to the ultrasonic sensor 34. The method proceeds with the step of generating a contoured map 38 of the acoustic pattern from the reflections of the ultrasonic waves. The method continues with analyzing the contoured map 38 to determine the quality of the at least one weld joint 22. In one embodiment, the analysis process includes automatically, such as with the computer 36 or the analysis device 42, comparing the contoured map 38 with known patterns for both good quality and defective welds to determine if the at least one weld joint 22 is good quality or defective. If the at least one weld joint 22 is determined to be defective, then the method proceeds with the step of alerting an operator of the failed weld joint so that the formation of a quality weld joint 22 can either be retried or so that the part can be scrapped or otherwise separated for analysis. The method proceeds with uploading the contoured map 38, along with any other data generated by the ultrasonic sensor 34 or by the controller 32, to a long-term storage database 44, which can either be local or remote, and associated with an identification number for the part.

An alternate setup includes the embodiment incorporating the ultrasonic sensor or probe can be located at the bottom of the electrode as shown in FIG. 2E to enable the same process as described in former sections.

Obviously, many modifications and variations of the present invention are possible in light of the above teachings and may be practiced otherwise than as specifically described while within the scope of the appended claims. Additionally, it is to be understood that all features of all claims and all embodiments can be combined with each other as long as they do not contradict each other.

1. A welding assembly, comprising:
at least one electrode in electrical communication with a power source and configured to run a current through a component and a base metal to create at least one weld joint between the component and the base metal;
an ultrasonic sensor joined with said electrode and configured to emit ultrasonic waves through the component and the at least one weld joint; and
an electronic device in electronic communication with said ultrasonic sensor and configured to generate an acoustic map of the at least one weld joint, the electronic device being configured to compare the acoustic map of the at least one weld joint to at least one predetermined threshold to establish a quality of the weld joint.

2. The welding assembly as set forth in claim 1 wherein said ultrasonic sensor is integral with said at least one electrode.

3. The welding assembly as set forth in claim 1 wherein said ultrasonic sensor is a separate component from said at least one electrode and is fixedly attached with said at least one electrode.

4. The welding assembly as set forth in claim 1 wherein the component is a fastener.

5. The welding assembly as set forth in claim 4 wherein the fastener is pre-formed with a plurality of projections that are configured to melt to form the at least one weld joint.

6. The welding assembly as set forth in claim 1 wherein the component and the base metal are made of the same type of metal.

7. (canceled)

8. The welding assembly as set forth in claim 1 wherein the component is a metal substrate that is pre-formed with projections.

9. A method of welding a component with a base metal, comprising the steps of:
welding a component with a base metal to create at least one weld joint using at least one electrode;
emitting ultrasonic waves from an ultrasonic sensor on an electrode and receiving reflections of those ultrasonic waves with the ultrasonic sensor;
generating an acoustic map based on the reflections of the ultrasonic waves; and
analyzing the acoustic map to determine a quality of the at least one weld joint.

10. The method as set forth in claim 9 wherein the ultrasonic sensor is integral with the electrode.

11. The method as set forth in claim 9 wherein the ultrasonic sensor is separate from the electrode and is fixedly attached with the electrode.

12. The method as set forth in claim 9 wherein the component is a fastener.

13. The method as set forth in claim 12 wherein the fastener is pre-formed with at least one projection that melts during the welding step.

14. The method as set forth in claim 9 wherein the component is a substrate.

15. The method as set forth in claim 9 wherein the welding step is drawn arc stud welding, capacitor discharge welding, or projection welding.

16. A welding assembly for welding a component with a base metal, comprising:
at least one electrode in electrical communication with a power source and configured to run a current through the component and the base metal to heat materials of the component and the base metal such that at least one weld joint is created between the component and the base metal;
an ultrasonic sensor joined with said electrode and configured to emit ultrasonic waves through the component and the at least one weld joint; and
an electronic device in electronic communication with said ultrasonic sensor and configured to generate an acoustic map of the at least one weld joint and compare at least one parameter of the acoustic map to at least one predetermined threshold to establish a quality of the at least one weld joint.

17. The welding assembly as set forth in claim 16 wherein said ultrasonic sensor is integral with said at least one electrode.

18. The welding assembly as set forth in claim 16, wherein said ultrasonic sensor is a separate component from said at least one electrode and is fixedly attached with said at least one electrode.

19. The welding assembly as set forth in claim 16, wherein the component is a fastener.

20. The welding assembly as set forth in claim 19, wherein the fastener is preformed with a plurality of projections that are configured to melt to form the at least one weld joint.

21. The welding assembly as set forth in claim 16, wherein the component is a metal substrate that is pre-formed with projections.
